(19) United States
(12) Patent Application Publication
(10) Pub. No.: US 2026/0019391 A1
(43) Pub. Date: Jan. 15, 2026

(54) COMMUNICATION GENERATION WITH ARTIFICIAL INTELLIGENCE SYSTEM

(71) Applicants: Merck Sharp & Dohme LLC, Rahway, NJ (US); MSD International B.V., Oss (NL); MSD Czech Republic s.r.o., Prague (CZ)

(72) Inventors: Jeevaka Kirella, Jersey City, NJ (US); Abhishek Singh, Short Hills, NJ (US); Aaditya Kurde, Hukmakhedi (IN); Guang Yang, Short Hills, NJ (US); Ziyu Qiu, Prague (CZ); Pranav Kumar Adiga, Harrison, NJ (US); Gleb Berdnikov, Belgrade (RS)

(21) Appl. No.: 18/767,602

(22) Filed: Jul. 9, 2024

(51) Int. Cl. H04L 51/04; G06F 40/186

(52) U.S. Cl. CPC H04L 51/04; G06F 40/186

(57) ABSTRACT

A system retrieves, from one or more databases, a set of data comprising rules related to communication preferences, information describing a plurality of candidate subjects for communications, and information describing candidate recipients. The system identifies candidate communications using the retrieved set of data, and each candidate communication has a subject of the candidate subjects and a target recipient of the recipients. The system retrieves contextual information related to the subjects and selects a communication from the candidate communications using the retrieved contextual information. The system may apply a model to the candidate communications and the retrieved contextual information to generate corresponding response metrics, and select the communication based on the response metrics. Each response metric indicates a likelihood that the target recipient of the corresponding candidate communication will have a desired response. The system generates a template for the communication including information about the subject of the communication.

### BACKGROUND

### Technical Field

This disclosure relates generally to artificial intelligence, and more particularly to generating communications using an artificial intelligence system.

### Background Information

Various methods have been implemented to create effective communications to recommend products and services to target recipients, including promoting brand/product awareness and persuading the customers/consumers/influencers/professionals in the field to make a purchase of target products. Traditionally, navigating the complexities of effective communications to professionals has relied heavily on a bundle of business rules and the intuition of salespeople. However, these traditional methods often fall short because they rely on pre-established rules and past experiences rather than real-time insights and data-driven decision-making. In one particular example, in the medical field, information is constantly evolving and existing approaches struggle to provide the recipients with the most relevant information at the right time and through the most effective channels.

### BRIEF DESCRIPTION OF THE DRAWINGS

The disclosed embodiments have various advantages and features which will be more readily apparent from the detailed description, the appended claims, and the accompanying figures (or drawings). A brief introduction of the figures is below.

FIG. 1 is a block diagram of a system environment suitable for providing artificial intelligence-generated communications, in accordance with an embodiment.

FIG. 2 is a block diagram of the recommendation system of FIG. 1, in accordance with an embodiment.

FIG. 3 is a flowchart depicting a computer-implemented process for generating communications, in accordance with an embodiment.

FIG. 4 is a graphical illustration showing the use of templates to generate communications (in this case email communications), in accordance with an embodiment.

FIG. 5 is a block diagram of an example machine suitable for use in the system environment of FIG. 1, in accordance with an embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described.

### Configuration Overview

In one embodiment, a computing system generates communications regarding a subject to a target recipient. The system retrieves, from one or more databases, a set of data including one or more of communication preferences, information describing candidate subjects for communications, or information describing candidate recipients. The system identifies candidate communications using the retrieved set of data, and each candidate communication has a subject of the candidate subjects and a target recipient of the recipients. The system retrieves contextual information related to the subjects and selects a communication from the candidate communications using the retrieved contextual information. The system may apply a model to the candidate communications and the retrieved contextual information to generate corresponding response metrics, and select the communication based on the response metrics. Each response metric indicates a likelihood that the target recipient of the corresponding candidate communication will have a desired response. The system generates a template for the communication including information about the subject of the communication.

In some aspects, this disclosure provides a recommender system and method for recommending an action using advanced artificial intelligence (AI)/machine learning (ML) algorithms to recommend a subject (e.g., a product/brand) to target recipients, such as, customers, consumers, influencers, professionals in order to create brand awareness and disseminate important information about the product/brand with a goal of increasing sales. For example, the disclosure provides a system and method for generating optimized and effective suggestions for promotions with related parameters.

Unlike traditional approaches, which may rely on generalized messaging or broad marketing tactics, this disclosure provides knowledge-driven communications which hinges on delivering tailored and timely information that resonates with the recipients' specific needs and preferences. The disclosed methods leverage data analytics to understand recipients' behavior, anticipate their informational needs, and deliver targeted messages through channels they are most likely to engage with. By adopting a more dynamic and knowledge-driven approach, communications can better adapt to evolving landscapes and meet the demands of informed and discerning recipients.

### System Overview

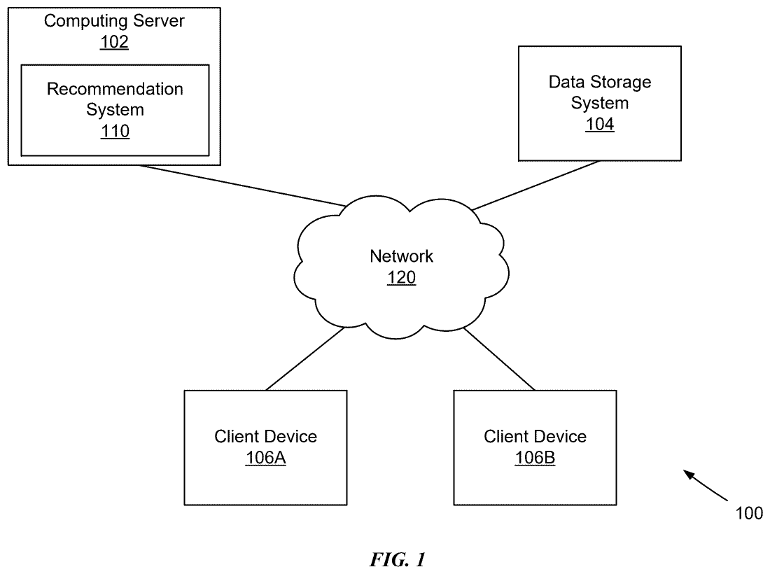

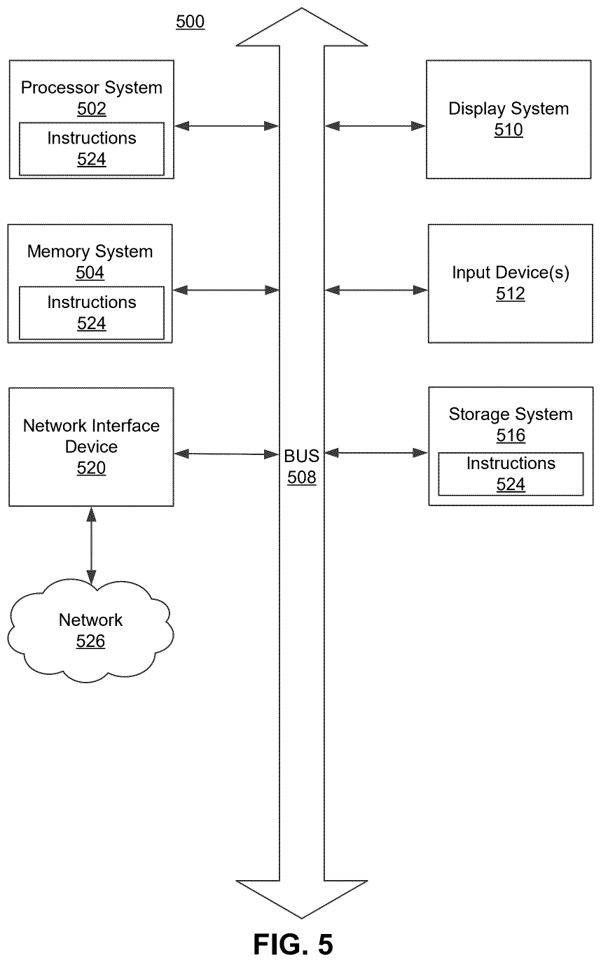

Figure (FIG. 1 is a block diagram of one embodiment of a system environment 100 suitable for providing artificial intelligence-generated communications. The system environment 100 shown in FIG. 1 includes one or more client devices 106A, 106B, a network 120, a computing server 102, and a data storage system 104. In some embodiments, the computing server 102 may include a recommendation system 110 that generates a communication to one or more recipients. For example, the communication may include a recommendation on a target subject matter (e.g., a medical product) to a target recipient (e.g., a physical doctor). Alternatively, the recommendation system 110 may be an external computing device that is independent of the computing server 102. While the recommendation system 110 is depicted as a component of the computing server 102, this is for convenience; the recommendation system 110 may be a single entity in environment 100, distributed across multiple servers, and the functionality of recommendation system 110 may, in whole or in part, be stored in computing server 102. In alternative configurations, different or additional components may be included in the system environment 100. The computing systems of the system environment 100 may include some or all of the components of a computer system 500 as described with FIG. 5.

The computing server 102 identifies communications regarding a subject to a target recipient. The computing server 102 retrieves communication preferences, information of candidate subjects or information of candidate recipients and generates communications using the retrieved information. Each candidate communication may include a subject of the candidate subjects and a target recipient of the recipients. The computing server 102 may retrieve contextual information related to the subjects and select a communication from the candidate communications using the retrieved contextual information. In some implementations, the computing server 102 applies a model to the candidate communications and the retrieved contextual information to generate corresponding response metric for each candidate communication, which indicates a likelihood of the respective target recipient having a desired response to the candidate communication. The computing server 102 may select the communication based on the response metrics and generate a template for the communication including information about the subject of the communication.

The data storage system 104 includes a device (e.g., a disk drive, a hard drive, a semiconductor memory) used for storing database data (e.g., a stored data set, portion of a stored data set, data for executing a query). In one embodiment, the data storage system 104 includes a distributed storage system for storing data and may include a commercially provided distributed storage system service. Thus, the data storage system 104 may be managed by a separate entity than an entity that manages the computing server 102 or the data storage system 104 may be managed by the same entity that manages the computing server 102.

In some embodiments, the data storage system 104 may store various background information and external knowledge related to candidate subjects and recipients, as well as historic user data. The data storage system 104 may store various types of information related to candidate subjects and recipient in communications. The data storage system 104 may be incorporated with the components of the computing server 102 and store one or more of rules related to communication preferences, information describing a plurality of candidate subjects for communications, information describing candidate recipients, or contextual information related to candidate subjects. The data storage system 104 may include pre-defined templates for presenting communications. The data storage system 104 may store mathematical algorithms, or training datasets that are used to train one or more machine learning models.

The client devices 106 are computing devices that display information to users and communicates user actions to the systems of the system environment 100. While two client devices 106A, 106B are illustrated in FIG. 1, in practice many client devices 106 may communicate with the systems of the system environment 100. In one embodiment, client devices 106 of the system environment 100 may include some or all of the components (systems (or subsystems)) of a computer system 500 as described with FIG. 5.

In one embodiment, a client device 106 executes an application allowing a user of the client device 106 to interact with the various systems of the system environment 100. For example, a client device 106 can execute a browser application to enable interaction between the client device 106 and the computing server 102 via the network 120. In another embodiment, the client device 106 interacts with the various systems of the system environment 100 through an application programming interface (API) running on a native operating system of the client device 106, such as IOS® or ANDROID™. The client device 106 may be any computing device. Example of such client device 106 may include a personal computer, a desktop, a laptop, a smart phone, a tablet, a wearable computing device such as a smart watch, an Internet-of-Things (IoT) device, and the like.

The network 120 includes any combination of local area or wide area networks, using wired or wireless communication systems. The network 120 may use standard communications technologies or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 120 may be encrypted using any suitable technique or techniques.

### Example System

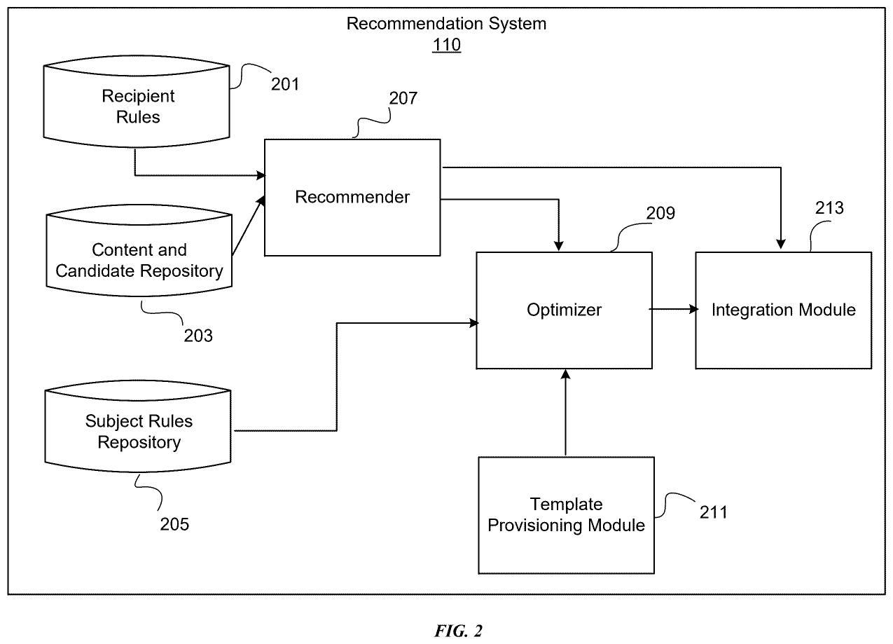

FIG. 2 illustrates one embodiment of the recommendation system 110. In the embodiment shown, the recommendation system 110 includes a recipient rules repository 201, a content and candidate repository 203, a subject rules repository 205, a recommender 207, an optimizer 209, a template provisioning module 211, and an integration module 213. The components depicted with respect to recommendation system 110 are exemplary; more, fewer, or different components may be used without deviating from the disclosed principles.

The recipient rules repository 201 stores rules that are related to communication preferences. In some embodiments, the communication preferences may include recipients' behavioral patterns, for example, preferred number of calls in a given time period (e.g., per week, per month, or per year); sending emails after a video conference, preference for utilizing emails over text messages, and the like. In some implementations, the recipient rules repository 201 may include a data table that stores recipients' communication rules/preferences. These preferences may be provided by the recipient, a salesperson assigned to the recipient, or inferred from prior behavior of the recipient. The data table may include multiple datasets with each dataset being associated with a recipient and including a set of parameters for describing the respective recipient. In some embodiments, the communication preferences may include preferred communication channels, such as email, phone, live chat, or social media. Additionally or alternatively, the communication preference may include recipients' personalized experiences tailored to their individual preferences, interests, and user history, examples may include: customized product recommendations, targeted marketing messages, personalized customer service interactions, and the like. These rules may be actual customer behavior/patterns as observed in the historic data or these rules may be synthetically generated (e.g., based on observation of the behavior of other customers identified as similar to a customer or provided by an operator based on the operator's prior experience).

The content and candidate repository 203 stores information of candidate subjects of communications and information of candidate recipients. The information of candidate subjects of communications may include content of a list of candidate products (e.g., medical devices, pharmaceutical products, etc.) for promotion. In some embodiments, the content for a subject may include product description highlighting its features (e.g., therapeutic effectiveness, mechanism of action, dosage formulation, etc.), visuals illustrations such as images or videos showcasing its functions/efficacy, unique selling proposition of the product, testimonials and reviews from satisfied customers or reputable sources, etc. Additionally or alternatively, the information of candidate subjects may include promotional offers, such as limited-time deals or discounts.

The information of candidate recipients may include a list of potential customers, such as healthcare providers (HCPs). In some embodiments, the information of candidate recipients may include the candidate recipient's contact information, demographic information, firmographic information (e.g., information about the candidate recipient's company or organization, such as industry, company size, annual revenue, number of employees, and geographic location). The information of candidate recipients may include the candidate recipient's qualification criteria, skill sets, practice areas, etc. The content and candidate repository 203 may update the information of the candidate subjects and candidate recipients periodically, on request, or in real time.

The subject rules repository 205 stores contextual information related to the candidate subjects. In some embodiments, the contextual information may include product/brand related rules, for example, content related to non-small cell lung cancer (NSCLC); content related to triple-negative Breast Cancer (TNBC), etc. In some embodiments, the contextual information may be related to rules of a medical product, such as details or circumstances surrounding the product that provide background context and medial knowledge for its understanding and usage. The contextual information may include a variety of factors that influence its application, efficacy, safety, and regulatory status. In one example, the contextual information includes indications and contraindications to dosage regimens and storage requirements, information that is used to make informed decisions about the selection, administration, and monitoring of medical treatments. In another example, the contextual information may include information such as compatibility considerations with other medications, potential adverse effects, regulatory approvals, and available clinical evidence. In yet another example, the context information may include regulatory status of the product, such as regulatory approvals, clearances, or certifications obtained from regulatory agencies. In some embodiments, the contextual information may further include business rules related to the candidate subject of the communication. In some implementations, the subject rules repository 205 may include a data table that stores contextual information related to the candidate subjects. The data table may include a set of parameters each with an indication weight in making recommendations.

The recommender 207 identifies candidate communications to one or more target recipients. A candidate communication may include at least one subject and at least one target recipient. In some embodiments, the candidate communications may include promotional recommendations on a medical product to one or more HCPs. For example, the candidate communication may include one or more candidate recipients, channels for promotions, frequency of promotions, etc. The recommender 207 may access a database that stores communications and identify/select communications from the database as candidate communications. Alternatively, the recommender 207 may generate candidate communication upon a user request.

In some embodiments, the recommender 207 retrieves data from one or more of the recipient rules repository 201, content and candidate repository 203, and subject rules repository 205 to generate/identify the candidate communications. In some embodiments, the recommender 207 may access data from external sources that are not shown in the figures but will be apparent to any person skilled in the art. In some embodiments, the input to the recommender 207 may include a user's request. For example, a user may specify in the request the requirement for generating/identifying the candidate communications, such as, candidate subject, target recipients, communication channels, formats, frequency, time, etc.

In some embodiments, the recommender 207 may use one or more algorithms, such as statistical algorithms, mathematical algorithms, machine learning algorithms, or artificial intelligence algorithms on the received input to generate/identify the candidate communications. For example, the recommender 207 may use a content-based filtering algorithm, a collaborative filtering algorithm, generative algorithm, etc., for recommending products based on the product's attributes and features, as well as a target recipient's past interactions or preferences. In another example, the recommender 207 may decompose product-recipient interaction data into latent factors or features, such as recipient preferences and subject characteristics and use these factors to make predictions about product-recipient interactions and generate/identify recommendations. In yet another example, the recommender 207 may use a machine learning model, such as neural networks, to learn patterns and relationships in large-scale product-recipient or communication-recipient interaction data. In still another example, the 207 may access a previously populated lookup table of actions and triggers and fetch action matching to one or more triggers. For example, the recommender 207 uses one or more of the inputs as triggers or trigger generators and looks up for a corresponding action in the look up table. Upon identifying a match, the recommender 207 may output the matching action in the generated communication.

The optimizer 209 is in communication with the subject rules repository 205 and the recommender 207 and selects a communication from the candidate communications based on the retrieved contextual information from the subject rules repository 205. In some embodiments, the optimizer 209 selects and optimizes the communication for providing the communication to at least one target recipient. In some embodiments, the optimizer 209 may apply a computational method capable of executing algorithms for selecting the communication. The computational method may include mathematical algorithms, rules-based algorithms, machine learning models, and the like. For instance, the algorithms may include linear programming algorithms or non-linear algorithms.

In one implementation, the optimizer 209 may apply a model to the candidate communications identified by the recommender 207 and the contextual information retrieved from the subject rules repository 205 to generate a response metrics for each candidate communication. Each response metrics may indicate a likelihood that the target recipient of the corresponding candidate communication will have a desired response to the candidate communication. The desire response may include interacting with the communication (e.g., clicking a fragment in the communication), providing feedback, sharing the communication, return visiting the communication, subscription of membership, purchasing the subject of the communication, etc. Based on the generated response metrics, the optimizer 209 may select the communication from the candidate communications for providing the communication to the target recipient of the communication. In some embodiments, the optimizer 209 may further modify/optimize the selected communication based on one or more of the corresponding information retrieved from the recipient rules repository 201, content and candidate repository 203, or subject rules repository 205.

In one example, the optimizer 209 may apply a model to generate the response metrics using the content distribution (V) and the communication preferences (v). The content distribution (V) may include various types of the content related to specific subject in the communication, for example, information describing the candidate subject, business rules, product rules, or the contextual information related to the subject, etc. The communication preferences (v) may be related to recipients' behavioral patterns or information describing the candidate recipients. The communication preferences (v) may be determined based on historic user data. The model may include an orchestration factor (2) that controls the influence of the communication preference on the content distribution. For example, the orchestration factor may weigh and balance the communication preference on the content distribution. In some examples, the model may also account for the number of promotion templates (K) and number of fragments (n). For example, n may refer to the number of fragments per template; alternatively, n may refer to the total number of fragments that are included in the candidate communications. In one implementation, the model may include an objective function presented as follows,

$$L = λ \cdot ‖ V - v ‖ + ( 1 - λ ) \cdot {\sum }_{i = 1}^{n} \frac{{P}^{m ax} - {P}^{selected}}{K} , \qquad ( 1 )$$

Here, P^{max} indicates a maximum likelihood that a target recipient of the corresponding candidate communication will have a desired response to the candidate communication, e.g., maximum click probability among the available fragments; and P^{selected} indicates a likelihood that a target recipient of the corresponding candidate communication will have a desired response to the candidate communication, e.g., click probability of a selected fragment. The objection function may be an optimize objective function that generates the response metrics for optimizing the communication.

In some embodiments, the orchestration factor (λ) is generated by one or more machine learning models. In another embodiment, the orchestration factor (λ) is generated using business rules (e.g., contextual information related to the subject). In yet another embodiment, the orchestration factor (λ) is generated using a large language model with an appropriate prompt. For example, the prompt may be generated using a user's input, e.g., request and queries. In a further embodiment, the orchestration factor (λ) may be generated using at least one mathematical or statistical algorithm.

The template provisioning module 211 generates templates for the communications. In some embodiments, the template provisioning module 211 may determine the content of a selected communication and identify a pre-defined template for presenting the selected communication based on the determined content. For example, the template provisioning module 211 may look up a database, e.g., a template repository, for identifying a suitable template for a given content type. The template provisioning module 211 may apply a machine learning model, e.g., a generative language model, to generate a template based on the content of the communication. The template provisioning module 211 may access the information from the recipient rules repository 201, content and candidate repository 203 and subject rules repository 205 for determining the template. A template may include elements/fragments that provide relevant information about the subject in communication, e.g., a recommended product. The template may be designed to obtain the target recipient's attention and encourage desired response to the communication. For example, a template may include one or more fragments for header, introduction, visual elements, etc. In some embodiments, the template may include user interface elements or user interactive elements that interacts with the recipient and receives recipient's response to the communication (e.g., clicking a fragment in the communication). The fragments and formats of the template may vary based on one of more of the communication preferences, information describing the subject in the communication, information describing the target recipient of the communication, and the contextual information related to the subject. In some implementations, based on the determined template for the selected communication, the optimizer 209 may further optimize the communication, for example, using a computational method to arrange and formatting the content of the communication into one or more selected templates.

The integration module 213 integrates the generated template with the selected communication for providing the selected communication to the target recipient. For example, the integration module 213 module may integrate the outputs from the optimizer 209 and template provisioning module 211 to create fragments within the template for the selected channel, content, and the recipient.

In some embodiments, the recommendation system 110 may include an interface module (not shown in FIG. 2) that provides interfaces to communicate with different parties and servers. The interface module may provide a portal in the form of a graphical user interface (GUI) for uses to input request to generate communications, specify rules of the communications, and select subjects and recipients for the communications. In some embodiments, the interface module may be in communication with the client devices 106 and cause the client devices 106 to present the generated communications and receive recipients' interactions with the generated communications.

### Communication Generation

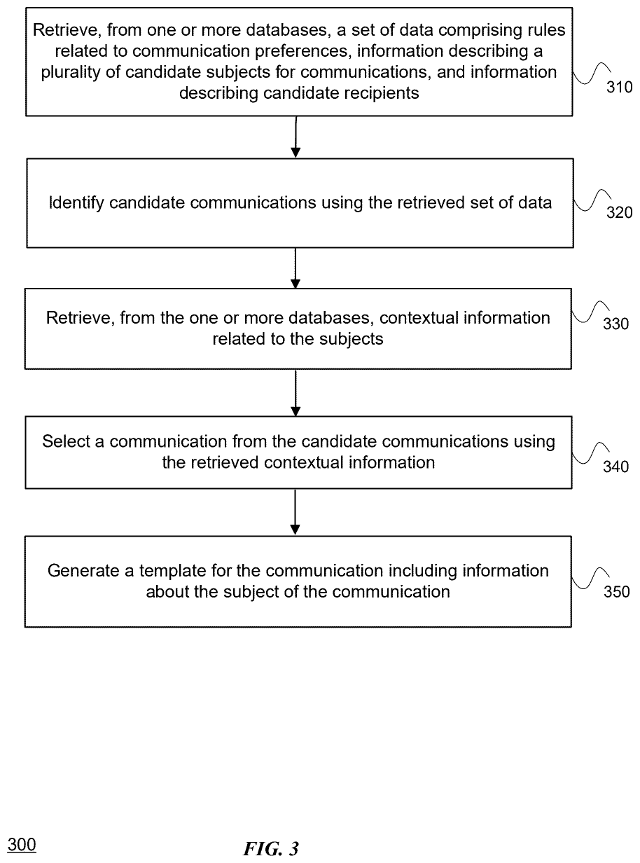

FIG. 3 is a flowchart depicting a computer-implemented process for generating communications, in accordance with an embodiment. A computer associated with the computing server 102 includes a processor and memory. The memory stores a set of code instructions that, when executed by the processor, causes the processor to perform some of the steps described in the process 300. In various embodiments, the process includes different or additional steps than those described in conjunction with FIG. 3. Further, in some embodiments, the steps of the process may be performed in different orders than the order described in conjunction with FIG. 3. The process described in conjunction with FIG. 3 may be carried out by the computing server 102 (e.g., the recommendation system 110) in various embodiments.

As shown in FIG. 3, the recommender 207 of the recommendation system 110 retrieves 310 a set of data from one or more databases. The one or more databases may include the recipient rules repository 201, the content and candidate repository 203, and the subject rules repository 205. In some embodiments, the retrieved data may include rules related to communication preferences, information describing a plurality of candidate subjects for communications, and information describing candidate recipients.

The recommender 207 may identify 320 candidate communications using the retrieved set of data. Each candidate communication may include a subject of the candidate subjects and a target recipient of the candidate recipients. In some examples, the candidate subjects may include one or more medical devices/products/services, the candidate recipients may include HCPs, and the communications may include recommendations of the one or more medical devices/products/services to the HCPs. In some embodiments, at least one of the candidate communications recommends a list of candidate subjects to a list of target recipients of the candidate recipients.

The optimizer 209 of the recommendation system 110 may retrieve 330 contextual information related to the subjects from the one or more databases. In some embodiments, the contextual information may include product/brand related rules. In some embodiments, the contextual information includes indications and contraindications to dosage regimens and storage requirements, information that is used to make informed decisions about the selection, administration, and monitoring of medical treatments. In another example, the contextual information may include information such as compatibility considerations with other medications, potential adverse effects, regulatory approvals, and available clinical evidence. In yet another example, the context information may include regulatory status of the product, such as regulatory approvals, clearances, or certifications obtained from regulatory agencies. In some embodiments, the contextual information may further include business rules related to the candidate subject of the communication.

The optimizer 209 may select 340 a communication from the candidate communications using the retrieved contextual information. In some embodiments, the optimizer 209 may apply a model to the candidate communications and the retrieved contextual information to generate corresponding response metrics. Each response metric indicates a likelihood that the target recipient of the corresponding candidate communication will have a desired response to the candidate communication. The optimizer 209 may select the communication based on the response metrics. The optimizer 209 may further modify the content of the selected communication based on the retrieved contextual information. In some implementations, the model may be a machine learning model. The optimizer 209 may apply the apply the model to generate the response metrics using the content distribution (V) and the communication preferences (v). The model may include an orchestration factor (λ) that weighs the contextual information for each of the candidate communications. In one implementation, the orchestration factor (λ) is generated by one or more machine learning models. In another implementation, the orchestration factor (Δ) is generated using business rules (e.g., contextual information related to the subject). In yet another implementation, the orchestration factor (λ) is generated using a large language model with an appropriate prompt. In a further embodiment, the orchestration factor (λ) may be generated using at least one mathematical or statistical algorithm.

The template provisioning module 211 of the recommendation system 110 may generate 350 a template for the communication including information about the subject of the communication. In some embodiments, the template provisioning module 211 may determine the content of the communication and identify a pre-defined template for presenting the selected communication based on the determined content. Alternatively, the template provisioning module 211 may provide the determined content to a machine learning model (e.g., large language model) to generate a template for presenting the selected communication.

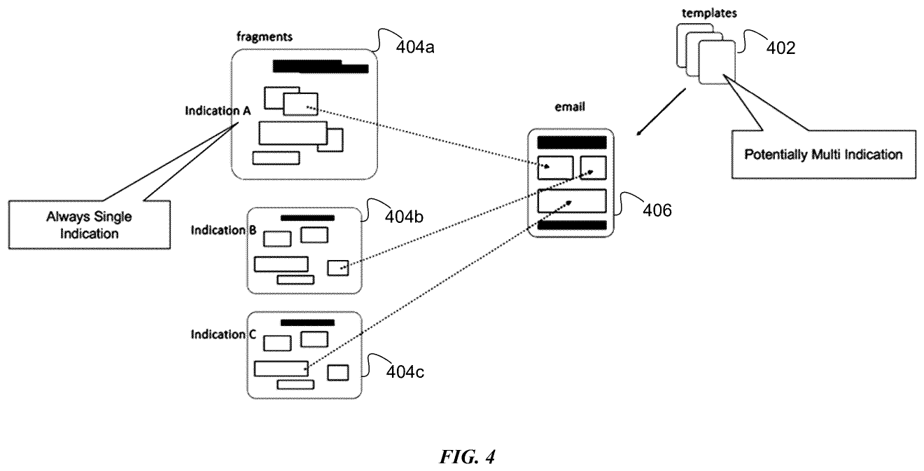

FIG. 4 is a graphical illustration showing the use of templates to generate communications, in accordance with an embodiment. In some embodiments, the template provisioning module 211 may access/generate one or more templates 402 to determine a templet for the communication. In some embodiments, the one or more templates 402 may include multiple indications for indicating the content or recipients associated with the templates. An indication may be used to indicate a medical condition, such as, disease, tumor, a stage of a tumor, etc. For example, an indication may include “TNBC,” indicating that the corresponding content or recipient is associated with TNBC. As another example, for a communication that recommends a medical product, the corresponding template may include one or more indications, such as, “Stage II of TNBC,” “NSCLC,” “Renal Cell Carcinoma (RCC),” etc., indicating the diseases/tumor that the medical product can be used for treatment. Based on the content of the communication, the template provisioning module 211 may create a plurality of sets of fragments, e.g., 404a, 404b, 404c, etc. Each set of fragments may include a plurality of fragments for presenting the content, e.g., text, image, interactive user interface element, etc. Each set of fragments may be associated with a single indication for the template provisioning module 211 to identify the corresponding set of fragments. The template provisioning module 211 may select a set of fragments to form a template 406 (e.g., an email) for providing the communication to the recipient.

In some embodiments, the integration module 213 of the recommendation system 110 may integrate the generated/selected template with the communication for providing the communication to the target recipient of the selected communication. For example, the integration module 213 may add the content of the communication to the template, and the recommendation system 110 provides the template including the content for presentation at a computing device.

In some embodiments, the recommendation system 110 may transmit the communication to the target receipt via various communication channels, e.g., email, text message, targeted advertisement in a webpage, phone call, etc. In some examples, the recommendation system 110 may transmit the communication The recommendation system 110 may determine a communication channel based on the communication and the target recipient. For example, the recommendation system 110 may apply a machine learning model to the content of the communication and predict a communication channel for transmitting the communication to the target recipient. In some embodiments, the integration module 213 may create fragments within the templates for integrating the content of the communication, the communication channel, and the target recipient. The recommendation system 110 may transmit the communication to the target recipient via the communication channel.

Turning now to FIG. 5, illustrated is an example machine suitable for use in the system environment of FIG. 1, in accordance with an embodiment. Specifically, FIG. 5 shows a diagrammatic representation of the computing server 102 (or data processing system) in the example form of a computer system 500. The computer system 500 is structured and configured to operate through one or more other systems (or subsystems) as described herein. The computer system 500 can be used to execute instructions 524 (e.g., program code or software) for causing the machine (or some or all of the components thereof) to perform any one or more of the methodologies (or processes) described herein. In executing the instructions, the computer system 500 operates in a specific manner as per the functionality described. The computer system 500 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 500 may be a server computer, a client computer, a personal computer (PC), a tablet PC, a smartphone, an internet of things (IoT) appliance, a network router, switch or bridge, or other machine capable of executing instructions 524 (sequential or otherwise) that enable actions as set forth by the instructions 524. Further, while only a single machine is illustrated, the term “machine” shall also be taken to include any collection of machines that individually or jointly execute instructions 524 to perform any one or more of the methodologies discussed herein.

The example computer system 500 includes a processing system 502. The processor system 502 includes one or more processors. The processor system 502 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 502 executes an operating system for the computing system 500. The computer system 500 also includes a memory system 504. The memory system 504 may include or more memories (e.g., dynamic random access memory (RAM), static RAM, cache memory). The computer system 500 may include a storage system 516 that includes one or more machine readable storage devices (e.g., magnetic disk drive, optical disk drive, solid state memory disk drive).

The storage unit 516 stores instructions 524 (e.g., software) embodying any one or more of the methodologies or functions described herein. The instructions 524 may also reside, completely or at least partially, within the memory system 504 or within the processing system 502 (e.g., within a processor cache memory) during execution thereof by the computer system 500, the main memory 504 and the processor system 502 also constituting machine-readable media. The instructions 524 may be transmitted or received over a network 526, such as the network 526, via the network interface device 520.

The storage system 516 should be taken to include a single medium or multiple media (e.g., a centralized or distributed database, or associated caches and servers communicatively coupled through the network interface device 520) able to store the instructions 524. The term “machine-readable medium” shall also be taken to include any medium that is capable of storing instructions 524 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 500 can include a display system 510. The display system 510 may driver firmware (or code) to enable rendering on one or more visual devices, e.g., drive a plasma display panel (PDP), a liquid crystal display (LCD), or a projector. The computer system 500 also may include one or more input/output systems 512. The input/output (IO) systems 512 may include input devices (e.g., a keyboard, mouse (or trackpad), a pen (or stylus), microphone) or output devices (e.g., a speaker). The computer system 500 also may include a network interface device 520. The network interface device 520 may include one or more network devices that are configured to communicate with an external network 526. The external network 526 may be a wired (e.g., ethernet) or wireless (e.g., WiFi, BLUETOOTH, near field communication (NFC).

The processor system 502, the memory system 504, the storage system 516, the display system 510, the IO systems 512, and the network interface system 520 are communicatively coupled via a computing bus 508.

### Additional Considerations

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Such computer program code may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

What is claimed is:

1. A method, comprising:
retrieving, from one or more databases, a set of data comprising rules related to communication preferences, information describing a plurality of candidate subjects for communications, and information describing candidate recipients;
identifying candidate communications using the retrieved set of data, each candidate communication having a subject of the candidate subjects and a target recipient of the recipients;
retrieving, from the one or more databases, contextual information related to the subjects;
selecting a communication from the candidate communications using the retrieved contextual information, the selecting comprising:
applying a model to the candidate communications and the retrieved contextual information to generate corresponding response metrics, each response metric indicating a likelihood that the target recipient of the corresponding candidate communication will have a desired response to the candidate communication, and
selecting the communication based on the response metrics; and
generating a template for the communication including information about the subject of the communication.

2. The method of claim 1, wherein selecting a communication from the candidate communications using the retrieved contextual information further comprises:
modifying content of the selected candidate communication based on the retrieved contextual information.

3. The method of claim 1, wherein the model includes an orchestration factor that weighs the contextual information for each of the one or more candidate communications.

4. The method of claim 1, wherein each response metric balances content distribution and communication preference of the corresponding candidate communication.

5. The method of claim 1, wherein generating the template for the communication comprises:
determining content of the communication; and
adding the content to a template; and
providing the template including the content for presentation at a computing device.

6. The method of claim 5, wherein generating the template further comprises:
providing the determined content to a machine learning model to select the template.

7. The method of claim 1, further comprising:
providing the communication to a machine learning model to determining a communication channel for transmitting the communication to the target recipient; and
transmitting the communication to the target recipient via the determined communication channel.

8. A non-transitory computer readable medium configured to store instructions, the instructions when executed by one or more processors causing the processor to perform operations comprising:
retrieving, from one or more databases, a set of data comprising rules related to communication preferences, information describing a plurality of candidate subjects for communications, and information describing candidate recipients;
identifying candidate communications using the retrieved set of data, each candidate communication having a subject of the candidate subjects and a target recipient of the recipients;
retrieving, from the one or more databases, contextual information related to the subjects;
selecting a communication from the candidate communications using the retrieved contextual information, the selecting comprising:
applying a model to the candidate communications and the retrieved contextual information to generate corresponding response metrics, each response metric indicating a likelihood that the target recipient of the corresponding candidate communication will have a desired response to the candidate communication, and
selecting the communication based on the response metrics; and
generating a template for the communication including information about the subject of the communication.

9. The non-transitory computer readable medium of claim 8, wherein selecting a communication from the candidate communications using the retrieved contextual information further comprises:
modifying content of the selected candidate communication based on the retrieved contextual information.

10. The non-transitory computer readable medium of claim 8, wherein the model includes an orchestration factor that weighs the contextual information for each of the one or more candidate communications.

11. The non-transitory computer readable medium of claim 8, wherein each response metric balances content distribution and communication preference of the corresponding candidate communication.

12. The non-transitory computer readable medium of claim 8, wherein generating the template for the communication comprises:
determining content of the communication; and
adding the content to a template; and
providing the template including the content for presentation at a computing device.

13. The non-transitory computer readable medium of claim 12, wherein generating the template further comprises:
providing the determined content to a machine learning model to select the template.

14. The non-transitory computer readable medium of claim 8, wherein the operations further comprise:
providing the communication to a machine learning model to determining a communication channel for transmitting the communication to the target recipient; and
transmitting the communication to the target recipient via the determined communication channel.

15. A system comprising memory with instructions encoded thereon that, when executed by one or more processors, cause the one or more processors to perform operations comprising:
retrieving, from one or more databases, a set of data comprising rules related to communication preferences, information describing a plurality of candidate subjects for communications, and information describing candidate recipients;
identifying candidate communications using the retrieved set of data, each candidate communication having a subject of the candidate subjects and a target recipient of the recipients;
retrieving, from the one or more databases, contextual information related to the subjects;
selecting a communication from the candidate communications using the retrieved contextual information, the selecting comprising:
applying a model to the candidate communications and the retrieved contextual information to generate corresponding response metrics, each response metric indicating a likelihood that the target recipient of the corresponding candidate communication will have a desired response to the candidate communication, and
selecting the communication based on the response metrics; and
generating a template for the communication including information about the subject of the communication.

16. The system of claim 15, wherein selecting a communication from the candidate communications using the retrieved contextual information further comprises:
modifying content of the selected candidate communication based on the retrieved contextual information.

17. The system of claim 15, wherein the model includes an orchestration factor that weighs the contextual information for each of the one or more candidate communications.

18. The system of claim 15, wherein each response metric balances content distribution and communication preference of the corresponding candidate communication.

19. The system of claim 15, wherein generating the template for the communication comprises:
determining content of the communication; and
adding the content to a template; and
providing the template including the content for presentation at a computing device.

20. The system of claim 19, wherein generating the template further comprises:
providing the determined content to a machine learning model to select the template.
